(19) United States
(12) Patent Application Publication
(10) Pub. No.: US 2004/0194330 A1
(43) Pub. Date: Oct. 7, 2004

(54) Measuring apparatus for determining the thickness of paper sheets or similar flat products

(75) Inventor: Heiko Zota, Ahrensburg (DE)

Correspondence Address: Friedrich Kueffner, Suite 910, 317 Madison Avenue, New York, NY, 10017, US

(73) Assignee: Pfankuch Maschinen GmbH

(21) Appl. No.: 10/815,268

(22) Filed: Mar. 31, 2004

(30) Foreign Application Priority Data
Apr. 3, 2003 (DE) 203 05 381.8

(51) Int. Cl. B41L 3/02

(52) U.S. Cl. 33/501.03

(57) ABSTRACT

A measuring apparatus for determining the thickness of sheets of paper or similar flat products, wherein the products to be measured are continuously fed on a counter pressure surface. A measurement roller which rests above the counterpressure surface on the product to be mesasured is rotatably mounted on a lever which is mounted so as to be pivotable about a shaft whose rotary movement is evaluated by an angle pickup or transmitter which converts the rotary movement into an electrical voltage change.

### BACKGROUND OF THE INVENTION

1. Field of the Invention The present invention relates to a measuring apparatus for determining the thickness of sheets of paper or similar flat products, wherein the products to be measured are continuously fed on a counterpressure surface.

2. Description of the Related Art

Measuring apparatus of the above-described type are used in the printing industry and paper processing industry. The apparatus are used for determining the thickness of sheets of paper, particularly for preventing feeding of two paper sheets which are placed one on top of the other, i.e., so-called double sheets. These known apparatus operate photooptically or electromechanically. In this type of measurement, the properties of the products to be measured are also determined, such as, the permeability to light, which provide no indications concerning the thickness and, thus, result in incorrect measurements.

### SUMMARY OF THE INVENTION

Therefore, it is the primary object of the present invention to provide a measuring apparatus of the above-described type which is simple and operates reliably.

In accordance with the present invention, a measurement roller which rests above the counterpressure surface on the product to be mesasured is rotatably mounted on a lever which is mounted so as to be pivotable about a shaft whose rotary movement is evaluated by an angle pickup or transmitter which converts the rotary movement into an electrical voltage change.

The electromechanical measuring apparatus according to the present invention utilizes the law of levers for determining and amplifying smallest differences in height. For this purpose, differences in height are converted into a rotary movement. The rotary movement is converted by the angle pickup into an electrical signal. By comparing a previously measured actual value with a predetermined reference value, the measured deviations are made clearly visible. A high response accuracy is achieved which amplifies the difference between the reference value and the actual value by a factor of several million. As a result, rotary movements of less than 1/1,000 degrees can be recognized with certainty. Measuring errors which are caused by temperature changes, can be compensated internally.

In accordance with an advantageous feature of the present invention, the lever is pivotable relative to a compression spring for damping overshooting.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of an embodiment of the measuring apparatus according to the present invention; and

FIG. 2 is a sectional view of the measuring apparatus of FIG. 1.

### DESCRIPTION OF THE PREFERRED EMBODIMENTS

The measuring apparatus, which also can be called an electromechanical “double arch control”, is mounted above a feeding path which is called counterpressure surface 3. The flat product 2 to be measured, for example, a sheet of paper, is fed through between the housing 4 of the measuring apparatus and the counterpressure surface 3.

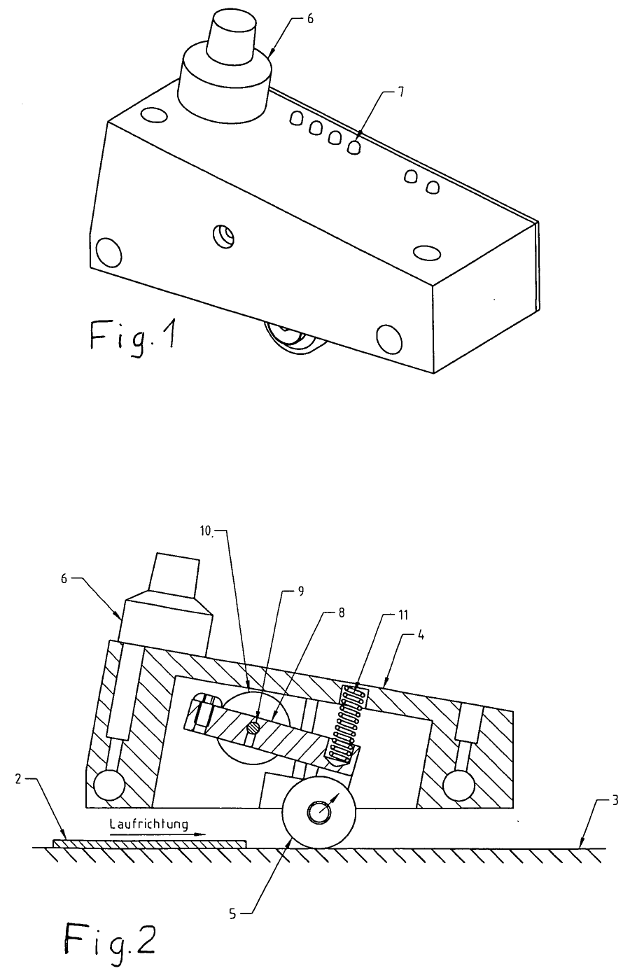

A measuring roller 5, which rests on the counterpressure surface 3, serves for determining large differences. Before production is started, a product to be measured is positioned underneath the measuring roller 5. The reference level corresponding to the thickness of a product is preadjusted by means of a potentiometers 6 illustrated in FIG. 1. The alignment of the reference level is supported by an optical indication 7.

When production is started, the products 2 to be measured travel underneath the measuring roller 5. This causes the measuring roller 5 to be lifted on the upper side of the product. The radially directed lifting movement of the measuring roller 5 is transmitted through a lever 8 to the shaft 9 of an angle pickup 10. The rotary movement of the shaft 9 is converted into an electrical voltage change which is evaluated electronically.

Due to the mass inertia of the measuring roller 5, overshooting occurs at the front edges of the products to be measured at higher conveying speeds. This behavior is compensated or minimized by a compression spring 11 mounted between the lever 8 and the housing 4.

The deviation from the reference level of the product to be measured is amplified by means of the lever whose upward and downward movements are transferred to the shaft 9 in the form of a rotary movement. The rotary movement of the shaft 9 is then converted into an electrical signal (voltage change) and is indicated and evaluated accordingly.

While specific embodiments of the invention have been described in detail to illustrate the inventive principles it will be understood that the invention may be embodied otherwise without departing from such principles.

I claim:

1. A measuring apparatus for determining a thickness of paper sheets or similar flat products, wherein the products to be measured are continuously fed on a counterpressure surface, the measuring apparatus comprising a measuring roller resting on the products to be measured above the counterpressure surface, wherein the measuring roller is rotatably mounted on a lever, and wherein the lever is pivotable about a shaft whose rotary movement is evaluated by an angle pickup which converts the rotary movement into an electrical voltage change.

2. The measuring apparatus according to claim 1, wherein the lever is mounted so as to be pivotable against a compression spring for damping overshooting.
